(19) United States
(12) Patent Application Publication
(10) Pub. No.: US 2010/0083948 A1
(43) Pub. Date: Apr. 8, 2010

(54) PROTECTIVE LINER AND SYSTEM FOR PROTECTING A COOKING TOP

(75) Inventors: Paolo Faraldi, Sanremo (IT); Alberto Gasparini, Fabriano (JP)

Correspondence Address: CESARI AND MCKENNA, LLP, 88 BLACK FALCON AVENUE, BOSTON, MA, 02210, US

(73) Assignee: Indesit Company S.p.A., Fabriano (Ancona) (IT)

(21) Appl. No.: 12/571,489

(22) Filed: Oct. 1, 2009

(30) Foreign Application Priority Data
Oct. 3, 2008 (IT) RN2008A000050

(51) Int. Cl. F24C 15/36; F24C 15/14; B32B 7/06

(52) U.S. Cl. 126/39 M; 428/40.1; 428/137; 428/192

(57) ABSTRACT

A protective liner for use with a cooking top is provided. The protective liner includes a base sheet and additional sheets which are geometrically similar to the surface of a cooking top. The protective liner shields the cooking top or a portion thereof from soil. Housing holes in the sheets delimit an area for corresponding cooking devices. The upper sheets are removable, leaving the base sheet as a clean sheet to shield the cooking top. An associated system is provided in which a stove having a cooking top with a surface through which one or more cooking devices are disposed has a protective liner to protect the cooking top surface from soil. The sheets of the protective liner are removable such that when a particular sheet is removed, an immediately adjacent sheet provides a clean outer aspect of the cooking top.

The present invention relates to a protective liner for at least a part of a first surface of a cooking top. The present invention also relates to a system comprising a cooking top and the protective liner.

Cooking tops for cooking food are known. Cooking tops normally comprise a first surface on which there are cooking points (typically gas and/or electric cookers or induction cookers).

The saucepans and frying pans containing the food to be cooked are placed on these cooking points and the first surface is subject to soiling.

For example, splashes of oil or sauces may often soil the first surface of the cooking top during cooking. In particular, the user may inadvertently soil the cooking top when handling pans and cutlery that have come into contact with the food.

This means that it is necessary to regularly clean the first surface. Since the remains of food or sauce tend to become encrusted over time, this cleaning should be carried out frequently. This obviously takes time by the user; the operation may also be tiring and require the use of detergents and sponges which obviously have their own cost.

Another shortcoming is that the first surface of the cooking top (which is often made of stainless steel) is exposed to the risk of the accidental formation of unsightly scratches, following, for example, contact with objects which are normally present in the kitchen (knives, pans, etc.) or as a result of rubbing with insufficiently soft sponges (used, for example, in an attempt to remove stubborn deposits).

In this context, the technical aim at the basis of the present invention is to provide a protective liner which overcomes the shortcomings of the above-mentioned prior art.

In particular, an aim of the present invention is to provide a protective liner which is able to help the user to keep the cooking top clean.

Another aim of the present invention is to provide a protective liner which provides the minimum operating cost.

A further aim of the present invention is to provide a protective liner which provides the maximum ease of operation.

Yet another aim of the present invention is to protect the cooking top against accidental and unsightly scratches.

The stated technical aim and the specified aims are substantially achieved by a protective liner, comprising the technical characteristics described in one or more of the attached claims.

Further characteristics and advantages of the present invention are apparent from the non-limiting description of a preferred embodiment of a protective liner which follows, as illustrated in the accompanying drawings in which:

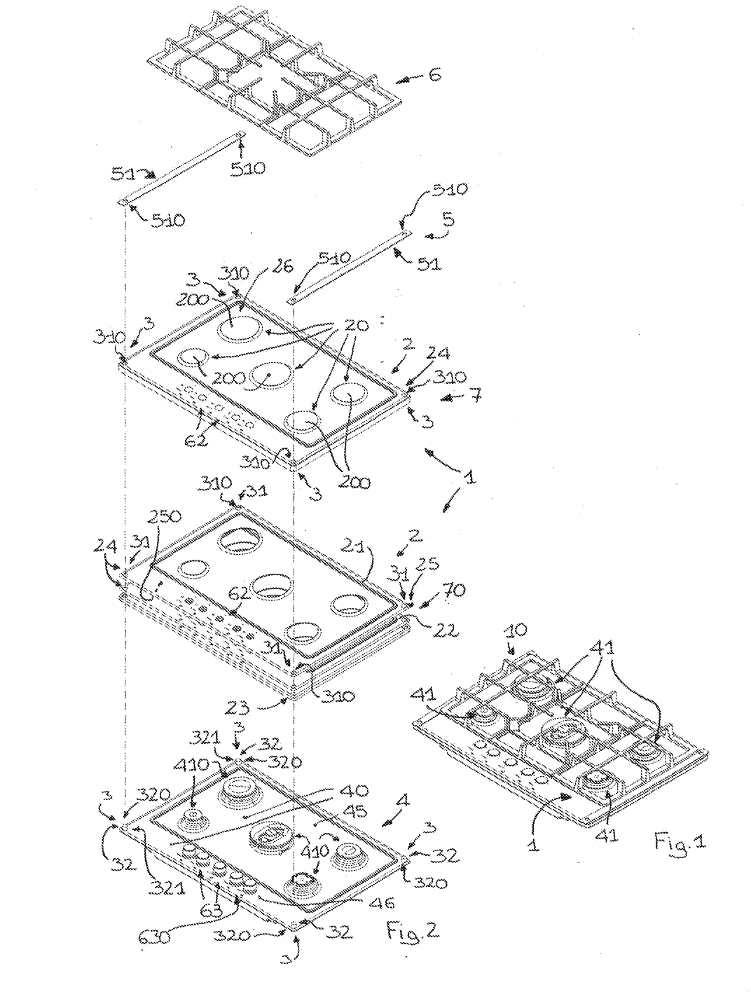

FIG. 1 is an overall view of a cooking top and a protective liner according to the present invention;

FIG. 2 is an exploded view of a cooking top and a protective liner according to the present invention.

With reference to the accompanying drawings, the numeral 1 denotes a protective liner for at least a part of a first surface 40 of a cooking top 4. Advantageously, the protective liner 1 rests (preferably lying on it completely) on the first surface 40 of the cooking top 4. In particular, the protective liner 1 covers and/or rests on a first surface 40 of the cooking top 4 on which there is at least one cooking point 41, the at least one cooking point 41 being described in detail below. The protective liner 1 is therefore an accessory of the cooking top 4. The protective liner 1 comprises a plurality of sheets 2 stacked one on top of the other and reciprocally separable. The user may therefore remove an outer sheet when it is soiled, this removal uncovering a clean sheet which was previously covered at least in part by the outer sheet that has been removed. Preferably, the sheets 2 are directly connected together, but in one particular embodiment the sheets 2 may not be directly connected together, but may merely rest on one another.

The stacked sheets 2 form a pack of sheets 2 and each sheet 2 of the protective liner 1 is in contact with one or more adjacent sheets 2.

In FIG. 2, the numeral 7 denotes a first group of two or more sheets 2, whilst the numeral 70 denotes another four sheets 2 which, in the exploded view, are illustrated separately from each other and from the first group 7 merely to illustrate more clearly.

Advantageously, each sheet 2 comprises at least one housing hole 20 to delimit an area 200 to house a cooking device 410 for a cooking top 4. Every cooking device 410 is associated with a cooking point 41. The cooking point 41 is an area in which, during cooking, a container (saucepan, frying pan, etc) containing the food to be cooked is placed. The cooking device 410 provides the energy necessary for cooking the food. This cooking device 410 may be supplied by gas or electrically (in this case having halogen or radiant heating means) or with an induction system (using a magnetic field produced by induction coils). As illustrated in the accompanying drawings, the at least one housing hole 20 surrounds the area 200.

In one embodiment not illustrated the housing hole 20 could also not be present. In this case, the cooking device 410 could remain completely beneath the protective liner 1. This could be the case if the cooking top 4 has an induction power supply; an induction power supply does not directly heat the cooking top 4 (even if the saucepan or frying pan containing the food to be cooked may also then transfer part of the heat to the cooking top 4 by conduction or convection). Advantageously, each sheet 2 comprises a plurality of housing holes 20. In particular, each sheet 2 comprises as many housing holes 20 as there are cooking devices 410 for the cooking top 4 (the cooking tops 4 normally have a plurality of cooking devices 410, one for each cooking point 41).

The sheets 2 may be made from various materials, depending also on the type of power supply for the cooking top 4. For example, the sheets 2 could be made from plastic material (e.g. polyethylene). Alternatively, the sheets 2 could also be made from other materials, such as, for example, a metal laminate (conveniently, but not necessarily, aluminium). In another particular embodiment at least one sheet 2 could be a multi-layer element (for example, a plastic layer and a metal layer inseparably connected together).

When the sheets 2 are stacked, the housing holes 20 of the various sheets 2 to house the cooking device 410 are reciprocally superposed.

Advantageously, the thickness of each sheet 2 is less than or equal to 1 millimetre. Advantageously, the thickness of each sheet 2 is greater than or equal to 0.1 millimetres. Preferably, but in no way limiting, the thickness of each sheet 2 is between 0.2 and 0.6 millimetres.

The protective liner 1 coincides with and/or comprises a pack of these sheets 2. Advantageously, the sheets 2 are disposable. This enables the maximum hygiene and speed to restore a clean sheet when the outer sheet of the protective liner 1 is soiled.

In general, the plurality of sheets 2 comprises at least a first and a second sheet 21, 22. The first sheet 21 comprises an adhesive layer for the movable connection with the second sheet 22.

Advantageously, each pack of sheets 2 may comprise a number of sheets 2 varying between 5 and 40, preferably between 10 and 20.

The plurality of sheets 2 comprises a base sheet 23 and a plurality of additional sheets 24 stacked on the base sheet 23.

During use, the base sheet 23 comes into contact with and rests on the cooking top 4. In particular, the base sheet 23 rests on a first surface 40 of the cooking top 4, the first surface 40 facing upwards (taking, as the reference, the physical vertical).

The first sheet 21 could be an additional sheet 24 or a base sheet 23, the second sheet 22 possibly being only an additional sheet 24.

In the present invention the word “sheet” not accompanied by other adjectives or specifications refers without distinction either to a base sheet 23 or to an additional sheet 24.

In the present invention the word “sheets” not accompanied by other adjectives or specifications, refers to at least any two sheets of the protective liner 1 (these sheets could, for example, all form part of the additional sheets 24 or one may be the base sheet 23 and the rest form part of the additional sheets 24).

During use, the base sheet 23 comes into contact with the cooking top 4.

During use, the base sheet 23 is placed between the additional sheets 24 and the cooking top 4. The additional sheets 24 comprise an adhesive surface portion 250 to enable the connection with a sheet 2 of the protective liner 1 immediately adjacent. Normally, the adhesive surface portion 250 touches at least one part of one of the two surfaces of the sheet 2. In a particular embodiment the adhesive surface portion 250 touches all of one of the two surfaces of the sheet 2. In particular, the adhesive surface portion 250 touches at least in part (preferably all of it) the surface of the additional sheet 24 facing the base sheet 23. All the additional sheets 24 have a surface facing the base sheet 23, regardless of whether there are other sheets 2 between the surface and the base sheet 23. Preferably, the base sheet 23 is not adhesive and is not designed to be glued on the cooking top 4. In an alternative non-preferred embodiment the base sheet 23 could also be adhesive to enable the connection with the first surface 40 of the cooking top 4. In a further embodiment the base sheet 23 could have a magnetic portion to enable the connection with the cooking top 4 if this were made of metal material (for reasons of cost, this embodiment is not to be considered the preferred embodiment, either). The thickness of the base sheet 23 could be greater than that of the additional sheets 24. Advantageously, the additional sheets 24 of the liner 1 are the same. In particular, all the sheets 2 of the liner 1 (both the base and additional sheets) could have a same geometry (or be identical, and therefore also made from the same material). The perimeter of these sheets 2 is not necessarily rectangular. In fact, advantageously, the perimeter of the sheets 2 follows the geometry of the first surface 40 of the cooking top 4.

The protective liner 1 comprises a stack of sheets 2, the two end sheets of the stack being the base sheet 23 and an operational sheet 26 (defined as such since it is the sheet that is subject to soiling during use).

When the operational sheet 26 is soiled, following, for example, the accidental spilling of sauces on it, it may be easily removed by the user who will uncover a new sheet 2 which is perfectly clean and previously covered by the removed sheet. The new sheet 2 thereby becomes the new operational sheet 26.

During use, the protective liner 1 lies approximately in a horizontal position with the base sheet 23 which covers at least in part a first surface 40 of the cooking top 4, the first surface 40 facing upwards and the cooking points 41 being positioned on the first surface 40. Consequently, the operational sheet 26, that is, the sheet 2 subject to soiling first, will be the upper one. By removing the soiled sheet 2 the user will uncover the underlying perfectly clean sheet 2. In the present invention the operational sheet 26 is also referred to as the outer sheet as it is the sheet which, during use, is the farthest from the first surface 40 of the cooking top 4.

At least one of the sheets 2 (preferably each one of them) comprises a lifting tab 25 to facilitate the separation of the sheet 2 from the remaining parts of the liner 1. The tab 25 projects out with respect to the remaining parts of the sheet 2. This tab 25 is normally placed along a perimetral portion of the sheet 2, advantageously at a corner formed by the perimeter of the sheet 2 (in the accompanying drawings, to simplify the illustration, the tab 25 is only illustrated on one of the sheets 2). In an alternative embodiment the tab 25 may be formed by a non-adhesive peripheral portion of the sheet 2, the portion being advantageously formed at a corner of the sheet 2 (the corner not necessarily being a vertex, but being rounded off in order to join two consecutive sides of the sheet 2). In the latter case, the tab 25 is delimited at least in part by an adhesive portion of the sheet 2.

The liner 1 may comprise first reference points 31 to enable positioning at second outer reference points 32 (placed typically on the cooking top 4). The first reference points 31 are means 3 of centring the liner 1 with respect to the cooking top 4 (as described in detail below). The first reference points 31 may comprise at least one centring hole 310 formed on each sheet 2 and designed to house protrusions 320 of the cooking top 4. Advantageously, the first reference points 31 comprise a plurality of centring holes 310 for each sheet 2 of the protective liner 1. In the simplified and non-limiting embodiment illustrated in the accompanying drawings the centring holes 310 are positioned at the four corners of each sheet 2 of the protective liner 1. Advantageously, the centring hole or holes 310 is/are separate from any housing holes 20.

The sheets 2 could be transparent to enable the underlying cooking top 4 to be seen, but they could also be either completely or partially opaque. In a particular embodiment the sheets 2 could be coloured. More in general, the sheets 2 could have a graphical decoration which is visible on the surface. This decoration is advantageously formed on a surface of the sheet 2 designed to be visible when the liner 1 is placed on the cooking top 4. In the embodiment in which the sheet 2 comprises an adhesive surface portion, this decoration is preferably formed on the surface of the sheet 2 opposite to the one on which the adhesive surface portion is formed. Advantageously, different sheets 2 of a same protective liner 1 could also have distinct and corresponding graphical decorations which are visible on the surface. In general, the graphical decorations enable the cooking top 4 to be personalised.

The present invention also relates to a system 10 comprising:
a cooking top 4 with a first surface 40 on which there is at least one cooking point 41;
a protective liner 1 which has one or more of the technical characteristics described previously.

The protective liner 1 rests at least on one surface portion of the first surface 40. In particular, the protective liner 1 overlaps at least in part the first surface 40 of the cooking top 4 and defines an area of surface contact with the first surface 40. Preferably, the portion of the liner 1 which overlaps the first surface 40 rests completely on the first surface 40. This first surface 40 is a surface which surrounds at least one cooking point 41. If there is more than one cooking point 41 the first surface 40 extends between several cooking points 41 of the cooking top 4. The first surface 40 forms part of the component of the cooking top 4 which in the specific trade is normally referred to as “cover”.

Each cooking point 41 is associated with a cooking device 410. In a first embodiment at least one of the cooking points 41 has a cooking device 410 comprising an electric hob or a gas ring which extends upwards from the first surface 40 of the cooking top 4. In a second embodiment not illustrated in which the cooking top 4 is an induction type, the first surface 40 comprises marks (signs or raised elements) indicating the cooking point 41 (that is, where to rest the container containing the food to be cooked).

Obviously, the absence of the protective liner 1 does not adversely affect the operation or the appearance of the cooking top 4. The cooking top 4 may also be used if the sheets 2 of the protective liner 1 have all been used and a new pack of spare protective sheets 2 is not available.

The system 10 comprises the means 3 for centring protective liner 1 with respect to the first surface 40 of the cooking top 4. The centring means 3 are formed in part on the protective liner 1 and in part on the cooking top 4 and they can interact reciprocally.

The centring means 3 comprise at least one protrusion 320 on the cooking top 4 and at least one corresponding centring hole 310 on the protective liner 1. The centring hole 310 surrounds the protrusion 320. Preferably, the centring hole 310 surrounds the protrusion 320 so that the clearance between the protrusion 320 and the centring hole 310 is less than or equal to 4 millimetres, preferably less than or equal to 2 millimetres. The at least one protrusion 320 is an example of the second outer reference points 32 referred to above. The centring hole 310 is an example of the first reference points 31 of the protective liner 1.

In particular, the centring means 3 comprise a plurality of protrusions 320 on the cooking top 4 and corresponding centring holes 310 on the protective liner 1.

These protrusions 320 are different to any protrusions linked to the presence of cooking devices 410 (for example, gas rings) positioned at the cooking points 41. Advantageously, the centring holes 310 are shaped to match the protrusion 320; for example, in the embodiment illustrated the protrusions 320 have a section at right angles to that of greatest length which has dimensions very similar or even the same as those of the centring holes 310. This enables easy insertion and extraction of the sheets 2 and precise positioning of the protective liner 1 with respect to the cooking top 4 by minimising any clearance. The presence of the centring means 3 is also very important if there is at least one housing hole 20 of a corresponding cooking device 410. Indeed, the centring means 3 are specifically dedicated to the positioning of the protective liner 1 with respect to a corresponding cooking top 4 and allow a smaller clearance with respect to any connection between housing hole 20 and cooking device 410.

The system 10 may comprise blocking means 5 designed to block the protective liner 1 when it is placed on the first surface 40 of the cooking top 4. These blocking means 5 may prevent the separation of a sheet 2 of the protective liner 1 from the remaining parts of the protective liner 1. These blocking means 5 hold the protective liner 1 firmly on the cooking top 4.

In the simplified and non-limiting embodiment illustrated in the accompanying drawings the blocking means 5 comprise at least one fastener 51 which may be connected to the cooking top 4. In particular, the fastener 51 is connectable to at least one protruding pin 321 on the cooking top 4. The fastener 51 has a hole 510 into which the pin 321 of the cooking top 4 fits and is fixed to the cooking top 4 by connection means, preferably threaded. The pin 321 of the cooking top 4 may have an end for passing completely through the fastener 51. In a possible embodiment the end is threaded and fitted with a threaded nut (not illustrated). In an alternative embodiment not illustrated a cap (preferably made of rubber) may be fitted to this end, which opposes the withdrawal of the fastener 51. In this case, the fastener 51 stays positioned between the cap and the protective liner 1.

Advantageously, the fastener 51 fits in two pins 321.

Advantageously there are at least two fasteners 51 which extend between two different pairs of pins 321 on the cooking top 4. Advantageously, the pins 321 on which the fastener 51 fits are the protrusions 320 of the centring means 3. In order to remove the operational sheet 2 it is necessary to unlock the threaded nuts and remove beforehand the fastener 51 or the fasteners 51.

In an alternative embodiment not illustrated the blocking means 5 comprise at least one spring clip on the cooking top 4. Advantageously, there are at least two spring clips. In order to withdraw the operational sheet 2 of the protective liner 1 it is necessary to move each clip by hand to overcome the elastic force to release a sheet 2 of the protective liner 1.

The protective liner 1 follows the extension of the first surface 40 of the cooking top 4 on which it rested.

Advantageously, this liner 1 almost completely superposes the first surface 40 of the cooking top 4.

In general during use, when the user wishes to replace one of the sheets 2 of the liner 1, the user performs the following operations:
releases the blocking means 5 of the protective liner 1;
pulls upwards the outermost sheet 2 of the protective liner 1 (that is, the sheet 2 farthest from the first surface 40 of the cooking top 4 on which the liner 1 is rested, the sheet being previously indicated as the operational sheet 26);
repositions the blocking means 5.

The blocking means 5 are auxiliary elements and, even though they are important for improved functionality, they could be absent.

As illustrated by way of an example in the accompanying drawing, before removing a sheet 2 of the protective liner 1 at least one pan support 6 for the containers (saucepans, frying pans, etc.) for cooking the food must be removed. The pan support 6, which is present in the case of gas cookers, is normally missing with other types of power supplies of the cooking top 4.

In the embodiment illustrated in the accompanying drawings, each sheet 2 has at least one passage 62 designed to enable the transit of a corresponding knob 63 for regulating the output of the cooking points 41. Advantageously, each sheet 2 has a plurality of passages 62, each designed to enable the transit of a corresponding knob 63. In the embodiment illustrated it could be convenient to remove the knobs 63 before removing the sheet 2 to be replaced. Alternatively, the passages 62 could be of such a size as to allow the sheet 2 to be extracted without interfering with the presence of the knob 63 (in this case, the dimensions of each passage 62 should be greater than the size of the corresponding knob 63).

The first surface 40 of the cooking top 4 comprises a cooking area 45 in which there is at least one cooking point 41. The pans containing the food to be cooked are placed in the cooking area 45. In the simplified and non-limiting embodiment illustrated in the accompanying drawings, the cooking area 45 coincides with the area beneath the pan support 6. The first surface 40 may also comprise an operating area 46 adjacent to the cooking area 45 in which there are means 630 for controlling the cooking top 4. These control means 630 comprise, for example, the knobs 63 for adjusting the output of the various cooking devices 410 or means for displaying information coming from the cooking top 4 (for example, a display). The portion of the protective liner 1 which is superposed on the display means is advantageously transparent. Alternatively, each sheet 2 could have an opening designed to overlap at least in part the display means (this is particularly advantageous if the sheets 2 of the protective liner 1 are not transparent; this enables the reading of the information by the display means). Advantageously, the perimeter of the sheets 2 follows the edge of the cooking area 45 or of the junction of the cooking area 45 and the operating area 46. In general, the sheets 2 of the protective liner 1 cover almost completely at least the cooking area 45. Advantageously, the sheets 2 of the protective liner 1 also cover the operating area 46. In particular, the protective liner 1 rests on the first surface 40 and covers almost completely the cooking area 45 and the operating area 46.

Advantageously, the entire protective liner 1 may be removed from the cooking top 4. This may take place, for example, when a graphical decoration is to be adopted which differs from the graphical decoration shown by one of the sheets 2 of the protective liner 1 currently in use.

The invention achieves important advantages.

Above all, it enables the cooking top 4 to be kept clean with the minimum effort.

It also enables the cooking top 4 to be protected from scratches which, during use, could inevitably occur.

The invention described herein is susceptible of industrial application and may be modified and adapted in several ways without thereby departing from the scope of the inventive concept.

Moreover, all the details of the invention may be substituted by technically equivalent means.

In practice, embodiments of the invention may be made from any material and in any size, depending on specific needs.

1-10. (canceled)

11. A protective liner for at least part of a first surface of a cooking top, the protective liner comprising:
a first sheet; and
one or more additional sheets stacked one on top of the other, forming a stack of sheets the stack being disposed on top of the first sheet, the stack of sheets on said first sheet being reciprocally separable and geometrically following the shape of the part of the first surface of the cooking top.

12. The liner as defined in claim 11, wherein each sheet has at least one housing hole to delimit an area to house a cooking device for a cooking top.

13. The liner as defined in claim 11 further comprising the first sheet and a second sheet, the first sheet having an adhesive layer for removable connection with said second sheet.

14. The liner as defined in claim 11 wherein said first sheet is a base sheet and said one or more additional sheets being stacked on the base sheet, the additional sheets having an adhesive surface portion for connection with an immediately adjacent sheet, the base sheet coming into contact during use with the cooking top, the adhesive surface portion of each additional sheet touching at least in part the surface of the additional sheet facing the base sheet.

15. The liner as defined in claim 11 further comprising at least one of the sheets having a lifting tab to facilitate the separation of the sheet of the protective liner from the remaining parts of the protective liner.

16. The liner as defined in claim 11 further comprising one or more reference points disposed on the sheets, the first reference point to enable positioning of the protective liner at second outer reference points disposed on the first surface of the cooking top.

17. A system comprising:
a cooking top having a first surface on which there is at least one cooking point; and
a protective liner being placed over at least part of the first surface and defining a area of surface contact with the first surface.

18. The system as defined in claim 17 further comprising means for centering the protective liner with respect to the first surface of the cooking top, the centering means being formed in part on the protective liner and in part on the cooking top and interacting reciprocally, the centering means comprising at least one protrusion on the cooking top and at least one corresponding centering hole on the protective liner, the centering hole surrounding the protrusion so that the clearance between the protrusion and the centering hole is less than or equal to 4 millimeters.

19. The system as defined in claim 17 further comprising:
blocking means designed to block the protective liner when it is placed on the first surface of the cooking top, the blocking means preventing the separation of a sheet of the protective liner from the remaining parts of the protective liner.

20. The system as defined in claim 17 further comprising:
the first surface of the cooking top having a cooking area in which there is at least one cooking point and an operating area adjacent to the cooking area in which there is a least part of the means of control of the cooking top, the protective liner resting on the first surface and covering the cooking area and the operating area substantially completely.
